(19) United States
(12) Patent Application Publication
(10) Pub. No.: US 2011/0258647 A1
(43) Pub. Date: Oct. 20, 2011

(54) OPTICAL PICKUP FEEDING DEVICE AND OPTICAL PICKUP SUPPORTING DEVICE INCLUDING THE SAME

(75) Inventors: Hidetoshi AKIMOTO, Kumagaya-shi (JP); Takeshi Aoki, Ota-shi (JP)

(73) Assignee: SANYO Electric Co., Ltd., Moriguchi-shi (JP)

(21) Appl. No.: 13/086,194

(22) Filed: Apr. 13, 2011

(30) Foreign Application Priority Data
Apr. 14, 2010 (JP) 2010-093144

(51) Int. Cl. G11B 7/08

(52) U.S. Cl. 720/663; G9B/7.041

(57) ABSTRACT

Multiple regulating portions protruding more than tooth portions of the rack are provided in positions, between which a feed shaft is interposed, in the vicinity of the tooth portions. Each regulating portion has an inclined surface which is opposed to a periphery of the feed shaft, and which is isolated more from the feed shaft as the inclined surface becomes farther from arm portions. Thereby, it is possible to restrain thin portions of the rack from twistedly deforming when the tooth portions come out of mesh with a groove of the feed shaft. In addition, it is possible to prevent the rack from coming off the feed shaft to a large extent.

This application claims priority from Japanese Patent Application Number JP 2010-093144, filed on Apr. 14, 2010, the content of which is incorporated herein by reference in its entirety.

### BACKGROUND OF THE INVENTION

1. Field of the Invention

The present invention relates to an optical pickup feeding device and an optical pickup supporting system including the same. Particularly, the present invention relates to a low-cost optical pickup feeding device capable of performing a stable optical pickup feeding operation, and an optical pickup supporting system including the same.

2. Description of the Related Art

An optical pickup supporting system (what is termed as a traverse mechanism) records and reads data to and from an optical disc by moving an optical pickup in the radial direction of the optical disc. In the conventional practice, the detection of the position of the optical pickup (the detection of whether the optical pickup is located in the innermost periphery or outermost periphery of the optical disc) is achieved by bringing the optical pickup into contact with a position detecting switch, which is provided to a fixture board (chassis) of the optical pickup supporting system, in the innermost periphery or in the outermost periphery.

In this case, however, there are such problems that: the optical pickup supporting system needs to be provided with the position detecting switch; and the number of parts is accordingly larger than otherwise. For this reason, a technology of detecting the home position of the optical pickup without using the position detecting switch has been developed. (This technology is described, for instance, in Japanese Patent Application Publication No. 2002-109839.)

According to Japanese Patent Application Publication No. 2002-109839, for example, the optical pickup is forcibly pressed against a supporting member of a guide shaft for slidably supporting the optical pickup, and a stepping motor for moving the optical pickup is forcibly driven more than needed for the optical pickup to be moved in a movable range of the optical pickup.

FIGS. 7A and 7B are diagrams showing another configuration for detecting the position of the optical pickup without using the position detecting switch. FIG. 7A is a schematic plan view showing the whole of an optical pickup supporting system (traverse mechanism) 50, and FIG. 7B is a perspective view showing an optical pickup driving member (rack) 60 which is used in the optical pickup supporting system 50.

A stepping motor 71, a feed shaft (lead screw) 72, a main guide shaft 53 and an auxiliary guide shaft 54 are fixed to a fixation board 51 which is a constituent of the traverse mechanism 50. The main guide shaft 53 and the auxiliary guide shaft 54 support an optical pickup 55 in a way that the optical pickup 55 is movable in the radial direction of an optical disc placed on a turntable 56.

The optical pickup 55 is supported by the driving member (rack) 60. The rack 60 includes: a main body portion 61 to which the optical pickup 55 is fixed; and tooth portions 62. For example, two tooth portions 62 are provided in a mesh (meshing) portion 63 of the rack 60. The tooth portions 62 are provided matching a spiral feed groove 73 of the lead screw 72 which is rotatably supported by the stepping motor 71, and are in mesh with the spiral feed groove 73. The lead screw 72 rotates in response to the drive of the stepping motor 71. Thereby, the rack 60 moves the optical pickup 55 in the radial direction of the optical disc (i.e., in the Z-axis direction).

A position detecting method of this case is as follows. When the optical pickup 55 moves, for example, up to an inner peripheral end of the optical disc, an end portion 60T of the rack 60 is brought into contact with the fixation board 51 (in FIG. 7A). Subsequently, the contact state forcibly continues for a predetermined length of time. Thereby, the movement load of the optical pickup 55 increases, and the torque needed for the stepping motor 71 accordingly increases. The change in the torque of the stepping motor 71 at this time is detected, and accordingly, it is recognized that the optical pickup 55 is located in the inner peripheral end or in the outer peripheral end.

The position detecting method using no position detecting switch in FIG. 7A needs a certain length of time with the end portion 60T of the rack 60 pressed against the fixation board 51 to detect the change in the torque of the stepping motor 71 when the optical pickup 55 moves up to the inner peripheral end or the outer peripheral end of the optical disc.

In addition, during this period of time, the lead screw 72 continues rotating although the optical pickup 55 is incapable of moving. For this reason, the torque of the stepping motor 71 which is applied to the tooth portions 62 of the rack 60 increases. Accordingly, the tooth portions 62 come out of mesh with their corresponding portions of the feed groove 73 of the lead screw 72, and jump into the adjacent portions (grooves) of the feed groove 73.

FIG. 8 is a side view of the mesh portion 63 and the lead screw 72 viewed in the X direction of FIG. 7A. In FIG. 8, the upward direction (Y direction) is a direction perpendicular to the data recording surface of the optical disc. When the tooth portions 62 begin to come out of mesh with their corresponding portions of the feed groove 73, as indicated by an arrow, the mesh portion 63 provided with the tooth portions 62 is elevated from the lead screw 72, for example, obliquely upward (in the YZ direction) along the feed groove 73. Once the tooth portions 62 completely come out of mesh with their corresponding portions of the feed groove 73, the tooth portions 62 come in mesh with the adjacent portions of the feed groove 73.

The rack 60 is an integrally-formed member made of, for example, synthetic resin. The rack 60 needs to be deformable to some extent for the purpose of allowing the tooth portions 62 to come into and out of mesh with the feed groove 73 during the detection of the change in the torque of the stepping motor 71. To this end, for example, thin portions 64T are respectively provided to arm portions 64 for supporting the mesh portion 63 (see FIG. 7B). However, the repetition of the mesh and release between the feed groove 73 and the tooth portions 72 brings about a problem that an extra load is imposed on the thin portions 64T.

Specifically, the thin portions 64T of the respective arm portions 64 deform, within the allowable range as designed, in a direction in which the mesh portion 63 moves away from or closer to the feed groove 73 (i.e., a direction of the depth of the feed groove 73, namely, the X-axis direction) which is perpendicular to a direction of the advancement of the optical pickup 55 (i.e., the Z-axis direction). However, when the mesh portion 63 is elevated, for example, obliquely upward (in the YZ direction) as indicated by the arrow in FIG. 8, the thin portions 64T of the respective arm portions 64 are twisted, that is to say, twistedly deform differently from the design intention.

The number of times the tooth portions 62 jump into the adjacent portions of the feed groove 73 (i.e., the thin portions 64T twistedly deform) during the detection of the change in the torque each time may be, for example, as small as two or three. However, as long as this is repeated every time the optical pickup 55 moves to the inner peripheral end or the outer peripheral end, the total number of times the tooth portions 62 jump into the adjacent portions of the feed groove 73 eventually reaches thousands or tens of thousands. By that, there arise problems in the durability, such as breakage of the rack 60, particularly, the thin portions 64T. In addition, during a drop test, the tooth portions 62 may come out of mesh with the feed groove 73 in some cases. In such cases, for example, if the deformation of the thin portions 64T is not set appropriately, it may be hard to recover the state of the mesh between the tooth portions 62 and the feed groove 73 from a state in which the tooth portions 62 sit on a circumferential surface 72S of the lead screw 72 in which no feed groove 73 exists. This raises a problem that no power can be transmitted stably.

Moreover, even while the optical pickup 55 is running, a problem arises in a case where the torque needed for the stepping motor 71 increases for some reason (for example, in a case where the movement load of the optical pickup 55 increases because the lubricant applied to the main guide shaft 53 runs short due to the long-time usage or the like). In other words, the increase in the movement load of the optical pickup 55 causes the same situation as the increase in the torque needed for the stepping motor 71 causes during the position detection in the inner peripheral end or in the outer peripheral end. For this reason, even if the tooth portions 62 do not come out of mesh with the feed groove 73, their mesh is shifted, and the power accordingly cannot be transmitted stably. Additionally, when the tooth portions 62 come in and out of mesh with the feed groove 73 as in the case of the position detection, this brings about a problem that the load imposed on the thin portions 64T of the rack 60 increases as well.

### SUMMARY OF THE INVENTION

This invention provides an optical pickup feeding device for moving an optical pickup in a radial direction of an optical disc including a feed shaft rotatably supported by a fixation board and provided with a spiral feed groove in a periphery of the feed shaft, a driving motor for rotating the feed shaft, and a driving member for driving the optical pickup by use of the driving motor and the feed shaft, wherein the driving member comprises: a main body portion to which the optical pickup is fixed; a tooth portion in mesh with the feed groove; an arm portion supporting the tooth portion and the main body portion in a way that the tooth portion and the main body portion are spaced; and a plurality of regulating portions provided in positions, between which the feed shaft is interposed, along the periphery of the feed shaft in a vicinity of the tooth portion.

The invention also provides an optical pickup supporting system including an optical pickup, a fixation board, a first shaft and a second shaft, provided to the fixation board, for supporting the optical pickup which moves in a radial direction of an optical disc, and the above optical pickup feeding device.

### BRIEF DESCRIPTIONS OF THE DRAWINGS

FIG. 1 is a perspective view showing an optical pickup supporting system of an embodiment of the present invention.

FIGS. 2A and 2B are respectively perspective and side views for explaining an optical pickup feeding device of the embodiment of the present invention.

FIGS. 3A and 3B are side views for describing the optical pickup feeding device of the embodiment of the present invention.

FIGS. 4A and 4B are respectively perspective and plan views showing a driving member of the embodiment of the present invention.

FIGS. 5A to 5C are respectively perspective and side views showing the driving member of the embodiment of the present invention.

FIGS. 6A and 6B are respectively side and perspective views for explaining the optical pickup feeding device of the embodiment of the present invention.

FIGS. 7A and 7B are respectively a plan view showing an optical pickup supporting system and a perspective view showing an optical pickup driving member for explaining a part of the prior art.

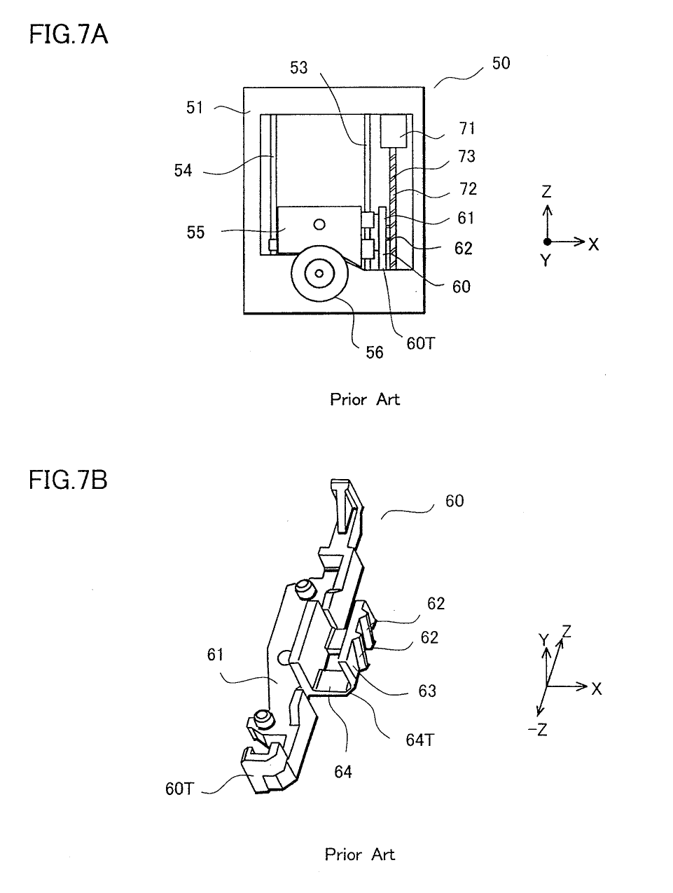

FIG. 8 is a side view for explaining the part of the prior art.

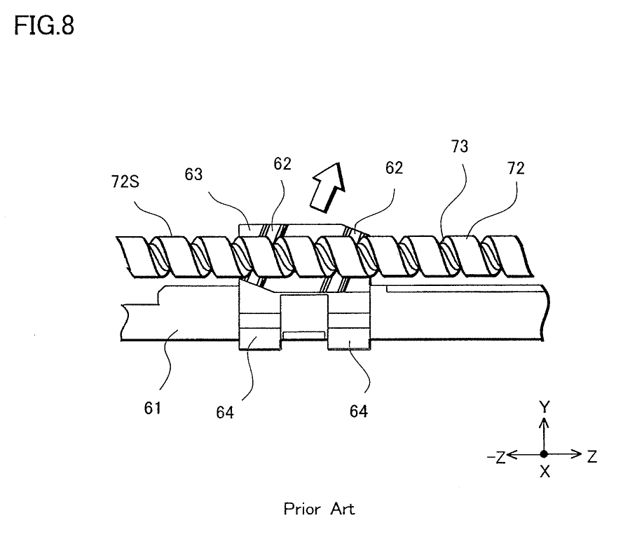

### DESCRIPTION OF THE PREFERRED EMBODIMENT(S)

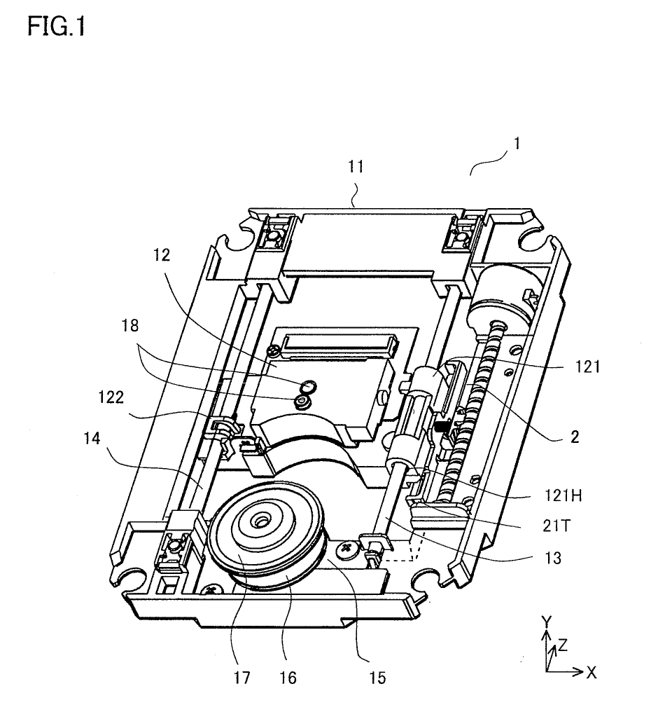

Detailed descriptions will be provided for the embodiment of the present invention by use of FIGS. 1 to 6B.

FIG. 1 is a perspective view showing an overview of an optical pickup supporting system of the embodiment. It should be noted that: the following drawings mainly show the main portions needed to explain the embodiment; and parts of the other portions are omitted from the drawings.

An optical pickup supporting system 1 is a system which is termed as a traverse mechanism, as well as includes a fixation board 11, an optical pickup 12, a first shaft 13, a second shaft 14 and an optical pickup feeding device 2.

A heat-resistive thermoplastic injection-moldable synthetic resin material, for example, is used as a base material of the fixation board (chassis) 11 which is a constituent of the optical pickup supporting system 1. Thereby, reduction in the weight and costs of the optical pickup supporting system 1 is achieved. A spindle motor 16 is provided in an end portion of the chassis 11. The spindle motor 16 is provided on a motor board 15, and the motor board 15 is fixed to the chassis 11. A turntable 17 is fitted to a rotary shaft of the spindle motor 16. An optical disc is put on the turntable 17.

Objective lenses 18 for collecting laser light on a signal surface of the optical disc and optical parts (not illustrated) for guiding the laser light emitted from a laser diode (not illustrated) to the objective lenses 18 are built in the optical pickup 12. Although the embodiment shows the case where the two objective lenses 18 are provided there, the number of objective lenses 18 may be one. The optical pickup 12 has guide portions 121, 122 in its two external ends.

The first shaft (main guide shaft) 13 and the second shaft (auxiliary guide shaft) 14 are fixed to the chassis 11 in a way that the first shaft 13 and the second shaft 14 are parallel to each other. The main guide shaft 13 and the auxiliary guide shaft 14 extend in one direction (in the Z-axis direction in FIG. 1) on one principal plane of the chassis 11. The cross sections of the main guide shaft 13 and the auxiliary guide shaft 14 are shaped almost like a circle. The main guide shaft 13 is inserted in a guide hole 121H provided in the guide portion 121, while the auxiliary guide shaft 14 is supported by a canopy-shaped portion of the guide portion 122 which is provided shaped like, for example, a horizontally-laid letter U.

By that, the optical pickup 12 is supported movable in the direction of the extension of the main guide shaft 13. The direction of the extension of the main guide shaft 13 (i.e., the Z-axis direction) is termed as a radial direction of the optical disc. In the following descriptions, the X-axis direction is defined as a direction which is orthogonal to the Z-axis direction, and which is directed from the optical pickup 12 toward the main guide shaft 13 (the auxiliary guide shaft 14). The X-axis direction is a direction perpendicular to the radial direction on the principal plane of the optical disc, and is termed as a tangential direction. In addition, the Y-axis direction is a direction perpendicular to the principal plane of the optical pickup 12 (a plane horizontal to a data recording surface of the optical disc), and is termed as a focusing direction.

The optical pickup feeding device 2 is fixed to an end portion along a side of the chassis 11, and moves the optical pickup 12 in the radial direction of the optical disc. A lubricant for enhancing the slidability of the guide portions 121, 122 of the optical pickup 12 is applied to the main guide shaft 13 and the auxiliary guide shaft 14. Thereby, the optical pickup 12 smoothly and securely reciprocates on the main guide shaft 13 and the auxiliary guide shaft 14 for a long time.

The optical pickup supporting system 1 emits the laser light through the objective lenses 18 of the optical pickup 2 to the optical disc which is rotated by the spindle motor 16. Subsequently, the optical pickup supporting system 1 reads the laser light reflected off the data recording surface of the optical disc by use of a photo-diode integrated circuit (PDIC) built in the optical pickup 12. In this respect, laser light in compliance with the Blu-ray disc (BD) standard, the digital versatile disc (DVD) standard or the compact disc (CD) standard is adopted as the laser light to be emitted from the optical pickup 12. Similarly, any one of these standards is adopted as the standard with which the optical disc rotated by the spindle motor 16 complies.

An optical disc apparatus is made up by housing the thus-configured optical pickup supporting system 1 in a case formed in a predetermined shape.

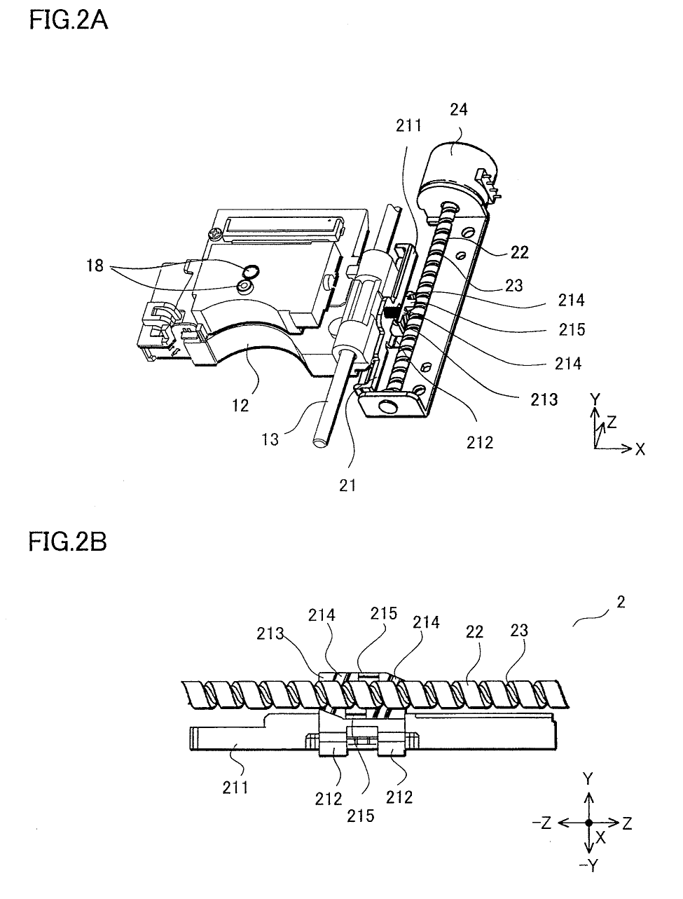

Referring to FIGS. 2A and 2B, descriptions will be provided for the optical pickup feeding device 2. FIG. 2A is a perspective view showing the optical pickup feeding device 2, and additionally shows the optical pickup 12 and the main guide shaft 13, which are fixed to the optical pickup feeding device 2, with thin continuous lines. FIG. 2B is a side view of a main part of the optical pickup feeding device 2 viewed in the X direction.

The optical pickup feeding device 2 includes a driving member 21, a feed shaft 22 and a driving motor 24.

The driving member (rack) 21 is an integrally-formed member for which a heat-resistive thermoplastic injection-moldable synthetic resin material is used as a base material. Examples of the adoptable synthetic resin material include polycarbonate which has hardness and properly elasticity, modified-polyphenylene ether (m-PPE).

The rack 21 includes a main body portion 211, arm portions 212, a mesh (meshing) portion 213, tooth portions 214, and regulating portions 215. The main body portion 211 is fixed to an end of the optical pickup 12, and thus supports the optical pickup 12.

The feed shaft 22 is, for example, a metal-made lead screw. A spiral feed groove 23 is provided in the periphery of the feed shaft 22. The tooth portions 214 provided in the mesh portion 213 of the rack 21 are in mesh with the feed groove 23.

The driving motor (stepping motor) 24 rotates the feed shaft 22 in a certain direction. Specifically, when an electric power is supplied to the stepping motor 24, the stepping motor 24 rotates at a predetermined angle in response to the pulse, and the lead screw 22 connected to the stepping motor 24 thus rotates. The rotational operation of the lead screw 22 moves the rack 21, whose tooth portions 214 are in mesh with the feed groove 23, in the direction of the extension of the lead screw 22 (i.e., the Z-axis direction). Thus, the optical pickup 12 fixed to the rack 21 is moved in the radial direction of the optical disc (i.e., the Z-axis direction).

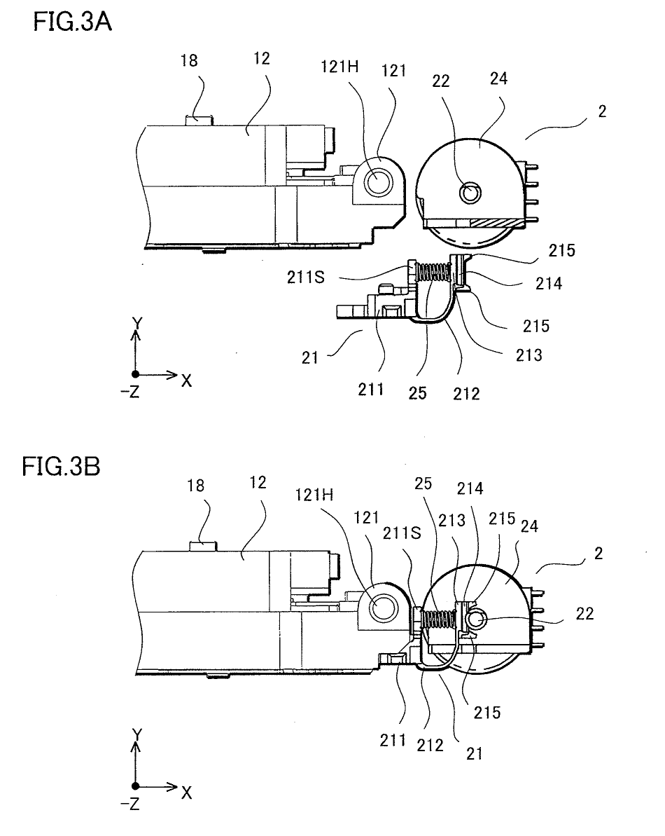

FIGS. 3A and 3B are diagrams showing a positional relationship among the optical pickup 12, the rack 21 and the lead screw 22. FIG. 3A is a diagram showing a disassembled state of the optical pickup 12, the rack 21 and the lead screw 22. FIG. 3B is a diagram showing an assembled state of the optical pickup 12, the rack 21 and the lead screw 22. FIGS. 3A and 3B both are side views of the optical pickup 12, the rack 21 and the lead screw 22 viewed in the -Z direction.

The main body portion 211 is fixed to the guide portion 121 on the main guide shaft side of the optical pickup 12 by a screw or the like and thus supports the optical pickup 12. A biasing member 25 for biasing (pressing) the mesh portion 213 toward the lead screw 22 (i.e., in the X direction) is provided between the main body portion 211 and the mesh portion 213 of the rack 21. The biasing member 25 is, for example, a coil spring. The two ends of the biasing member 25 are respectively fitted to protrusions (not illustrated) provided to a side surface 211S of the main body portion 211 and the mesh portion 213. While assembled together (FIG. 3B), the tooth portions 214 of the rack 21 are brought into press-contact with the feed groove of the lead screw 24 by the coil spring 25. Thus, the tooth portions 214 are put in mesh with the feed groove. In other words, the coil spring 25 keeps the tooth portions 214 in mesh with the feed groove appropriately.

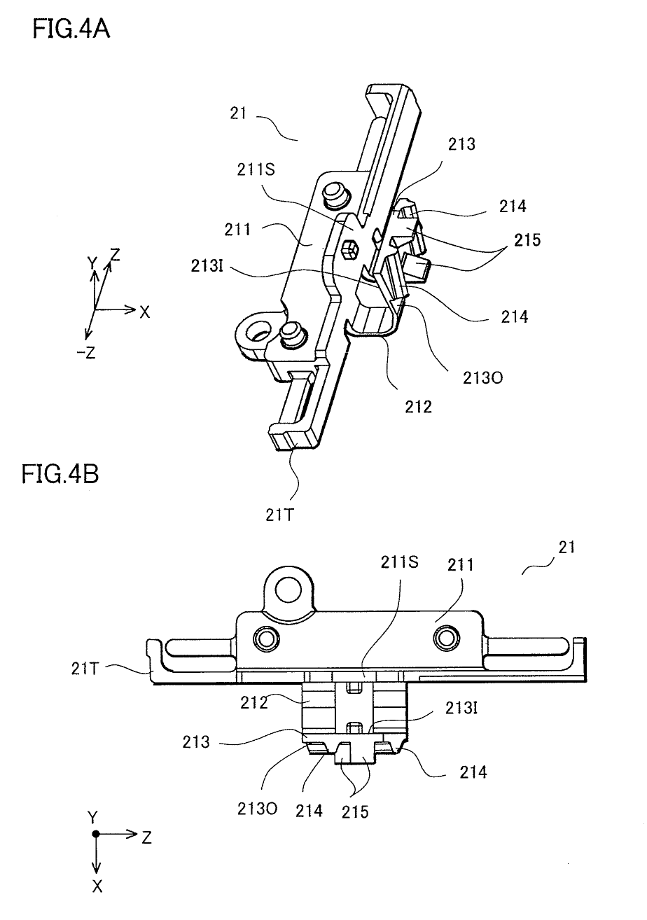

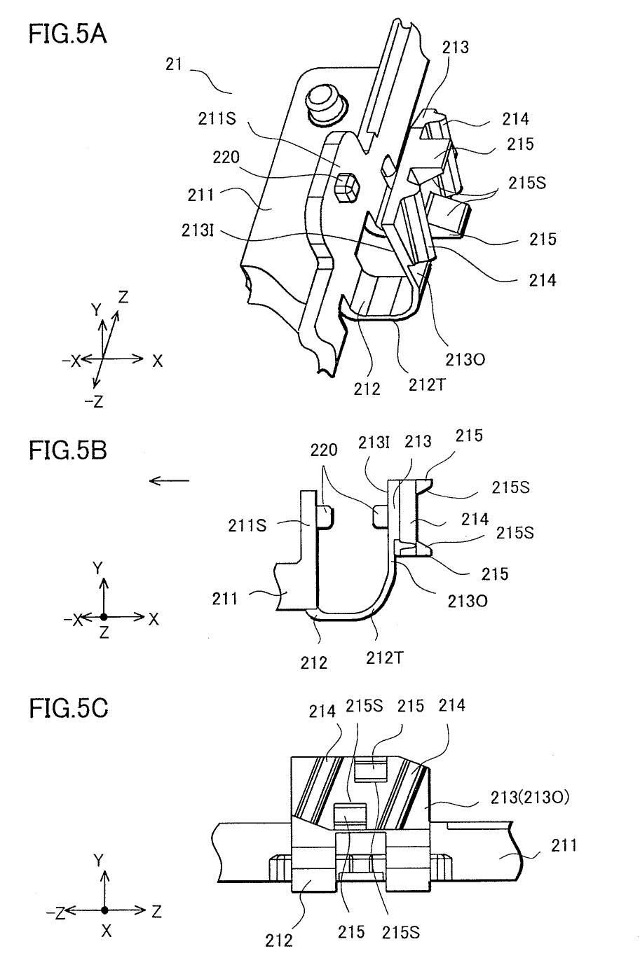

Referring to FIGS. 4A to 5C, detailed descriptions will be provided for the rack 21. FIG. 4A is a perspective view showing an overall configuration of the rack 21, and FIG. 4B is a plan view of the rack 21 viewed in the Y direction. In addition, FIG. 5A is a magnified view of a main part of the rack 21 shown in FIG. 4A. FIG. 5B is a side view of the main part of the rack 21 shown in FIG. 5A, which is viewed in the -Z direction. FIG. 5C is a side view of the main part of the rack 21 shown in FIG. 5A, which is viewed in the X direction.

Referring to FIGS. 4A and 4B, the mesh portion 213 is provided almost in parallel to the side surface 2115 of the main body portion 211, and is isolated from the main body portion 211 at a predetermined distance, as well as is supported by the arm portions 212. The cross section of each arm portion 212 in the X-axis direction is shaped like a curve, such as the letter U or the letter J. The main body portion 211 and the mesh portion 213 are situated in the two ends of each arm portion 212, respectively.

Referring to FIGS. 5A and 5B, the mesh portion 213 has two principal surfaces. Hereinafter, one principal surface opposed to the side surface 211S of the main body portion 211 will be referred to as an inner wall 213I, and the other principal surface in the back of the inner wall 213I will be referred to as an outer wall 213O. The tooth portions 214 and the regulating portions 215 are provided on the outer wall 213O of the mesh portion 213.

In addition, the protrusions 220 to which the coil spring 25 is fitted are respectively provided on the side wall 211S of the main body portion 211 and the inner wall 213I of the mesh portion 213.

Referring to FIGS. 5A, 5C and 2B, the multiple (for example, two) tooth portions 214 are provided along the feed groove 23 of the lead screw 22, and tilting from the Y-axis at a predetermined angle. Each tooth portion 214 is shaped almost like a triangle pole in a way that: that the tooth portion 214 protrudes toward the lead screw 22 (i.e., in the X direction) in order to be in mesh with the feed groove 23; and the tooth portion 214 has a curvature at its vertex portion, for example.

The regulating portions 215 are provided in the vicinity of the tooth portions 214, and along the periphery of the lead screw 22, as well as in positions between which the lead screw 22 is interposed. To put it more specifically, two regulating portions 215 are provided between the two adjacent tooth portions 214 in a way that the diameter of the lead screw 22 in the Y-axis direction is interposed between the upper and lower regulating portions 215.

The Y direction is a direction perpendicular to the data recording surface of the optical disc. In other words, the regulating portions 215 are provided in the respective upper and lower places of the lead screw 22 in a way that a surface, which is almost horizontal to the data recording surface of the optical disc, in a peripheral surface 22S of the lead screw 22 is interposed between the regulating portions 215.

The regulating portions 215 are protrusions which protrude from the outer wall 213O of the mesh portion 213 toward the lead screw 22 (i.e., in the X direction). The height with which each regulating portion 215 protrudes is higher than the height with which each tooth portion 214 protrudes. For example, each regulating portion 215 reaches the vicinity of the axial center of the lead screw 22 (see FIGS. 5A, 5B and 3B).

In addition, in each regulating portion 215, its surface opposed to the lead screw 22 is an inclined surface 215S along the curvature of the periphery of the lead screw 22. This embodiment is shown in the case where the inclined surface 215S is provided in a flat form. Instead, however, the inclined surface 215S may be one which has a curvature along the periphery of the lead screw 22.

Each aim portion 212 has a thin portion 212T in its part. As described above, the rack 21 as a whole is integrally formed from the synthetic resin. Each arm portion 212 is flexible mainly in the X-axis direction because of its curved shape and the thin portion 212T. In other words, each arm portion 212 is designed to be capable of recovering its original shape even in a case where the arm portion 212 deforms in the X-axis direction (mainly in the -X direction) to some extent. Furthermore, in this embodiment, the coil spring 25 also makes it easy for each arm portion 212 to recover its original shape from a state in which the arm portion 212 deforms in the -X direction.

The following should be noted. In FIG. 5C, the upper regulating portion 215 and the lower regulating portion 215 are provided in their respective positions which make the centers of the regulating portions 251 in the Z-axis direction shifted rightward and leftward, respectively. However, the upper regulating portion 215 and the lower regulating portion 215 may be arranged in a way that their centers are situated on the same Y axis.

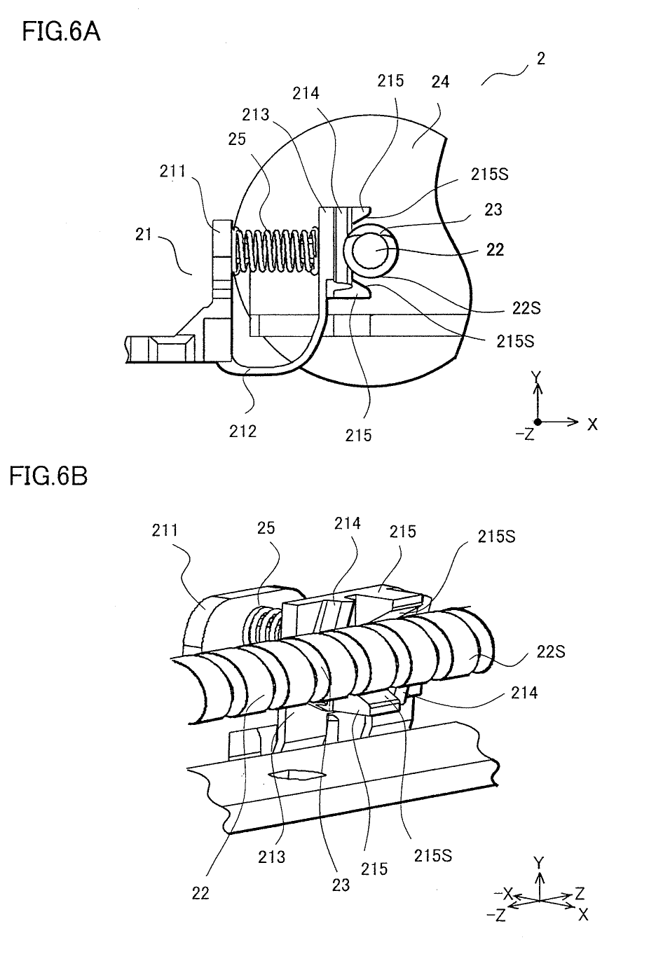

FIGS. 6A and 6B are diagrams showing the state of the lead screw 22 and the mesh portion 213 of the rack 21. FIG. 6A is a side view of the state of the mesh between the feed groove 23 and the tooth portions 214, which is viewed in the -Z direction. FIG. 6B is a perspective view for explaining the state in which the tooth portions 214 are out of mesh with the feed groove 23.

Referring to FIG. 6A, while the optical pickup is in a regular (normal) running condition, the tooth portions 214 of the rack 21 are in mesh with the feed groove 23 of the lead screw 22, and the rack 21 moves in the Z-axis direction due to the rotation of the lead screw 22. While in this condition, the regulating portions 215 are out of contact with the lead screw 22.

Referring to FIG. 1 together, descriptions will be provided for a case where the optical pickup 12 moves up to the inner peripheral end or in the outer peripheral end.

In a case where a new optical disc is placed on the turntable, or in a case where data is read or written from or to the optical disc up to the innermost periphery or the outermost periphery, the optical pickup 12 moves up to, for example, the inner peripheral end of the optical disc, and an end portion 21T of the rack 21 is brought into contact with an inner wall of the chassis 11, which is indicated by the dashed line. Subsequently, this embodiment forcibly continues a state in which the optical pickup 12 is incapable of moving and is in contact with the inner wall of the chassis 11 for a predetermined length of time. This increases the movement load of the optical pickup 12, and accordingly increases the torque needed for the stepping motor 24. At this time, the fact that the optical pickup 12 is located in the inner peripheral end is recognized by detecting the change in the torque of the stepping motor 24.

Referring to FIG. 6B, while the position of the optical pickup 12 is being detected, the lead screw 22 continues rotating although the optical pickup 12 is incapable of moving. For this reason, the torque of the stepping motor 24, which is added to the tooth portions 214, increases as well. Accordingly, the tooth portions 214 of the rack 21 come out of mesh with the feed groove 23 of the lead screw 22.

In this embodiment, when the tooth portions 214 of the rack 21 come out of mesh with the feed groove 23 and climbs onto the peripheral surface 22S of the lead screw 22 between adjacent portions of the feed groove 23, the peripheral surface 22S of the lead screw 22 comes into contact with the inclined surfaces 215S of the respective regulating portions 215. In other words, the inclined surfaces 215S are formed with an angle and a shape which do not allow the inclined surfaces 215S to be in contact with the lead screw 22 while the optical pickup 21 is in a regular (normal) running condition, and which bring the inclined surfaces 215S into contact with the peripheral surface 22S when the tooth portions 214 climb onto the peripheral surface 22S.

In addition, the inclined surfaces 215S of the respective regulating portions 215 form a bowl-shaped guide. When the peripheral surface 22S of the lead screw 22 is brought into sliding contact with the inclined surfaces 215S, the arm portions 212 are almost restrained from deforming in a vertical direction (i.e., in the Y-axis direction) (which is perpendicular to the data recording surface of the optical disc). Accordingly, the arm portions 212 change in shape (deform) mainly in the forward and backward direction (i.e., in the -X direction) (in a direction in which the arm portions 212 leave the feed shaft in a direction almost horizontal to the data recording surface of the optical disc).

Strictly speaking, the mesh portion 213 slightly moves upward and downward when the tooth portions 214 come out of mesh with the feed groove 23. However, the range of the upward and downward movement does not become equal to or larger than the distance between the opposed regulating portions 215 (i.e., between the opposed inclined surfaces 215S). For this reason, one may say that almost all the deformation in the vertical direction is restrained unlike in the conventional case.

When the lead screw 22 further continues rotating with the arm portions 212 deforming in the -X direction and with the tooth portions 214 sitting on the peripheral surface 22S, the tooth portions 214 come into mesh with the next portions of the feed groove 23, and the arm portions 212 recover their original state due to their shape and the coil spring 25.

In this embodiment, even though the tooth portions 214 come out of mesh with the feed groove 23 multiple times (for example, twice or three times) while the position of the optical pickup 12 is being detected, the arm portions 212 deform mainly in the X-axis direction as described above.

The arm portions 212 are designed in a way that the arm portions 212 are allowed a desirable deformation in the X-axis direction, which is a direction tangential to the optical disc, by selecting the curved shape and the thin portions 212T depending on the necessity. In other words, it matters little if the arm portions 212 deform in the X-axis direction due to the detachment of the tooth portions 214 from the feed groove 23. However, when the mesh portion 213 is elevated, for example, obliquely upward (in the YZ direction) to a large extent due to the detachment, the thin portions 212T of the respective arm portions 212 are twisted, that is to say, twistedly deform differently from the design intention.

In this embodiment, because the regulating portions 215 are provided there, the arm portions 212 do not deform obliquely upward (in the YZ direction) along the feed groove 23 to a large extent unlike in the conventional case. Accordingly, it is possible to inhibit the arm portions 212 from breaking due to the repetitive position detections.

As is sometimes the case with the prior art, during a drop test, the mesh portion 213 slides in the vertical direction (i.e., in the focusing direction, or in the Y-axis direction) to a large extent, and the tooth portions 214 come out of mesh with the feed groove 23. In such a case, if the deformation of the tooth portions 212 (for example, the deformation of the thin portions 212T, the shape of the aim portions 212, and the biasing force of the coil spring 25) is set inappropriately, it may be sometimes hard to recover the state of the mesh between the tooth portions 214 and the feed groove 23.

For example, if the mesh portion 213 shifts upward to a large extent and the lower ends of the respective tooth portions 214 thus climb onto the peripheral surface 22S of the lead screw 22 (in other words, the mesh portion 213 as a whole climbs onto the lead screw 22), the prior art causes a problem that: it is hard to recover the state of the mesh between the tooth portions 214 and the feed groove 23 from such a state; and the power accordingly cannot be transmitted stably.

In the embodiment, however, because the regulating portions 215 protruding up to the vicinity of the center of the lead screw 22 are provided in a way that the lead screw 22 is vertically interposed between the regulating portions 215, it is possible to restrain the mesh portion 213 from sliding in the vertical direction (i.e., in the Y-axis direction) to a large extent, and the tooth portions 214 from coming out of mesh with the feed groove 23, during a drop test. In addition, even if the tooth portions 214 come out of mesh with the feed groove 23, it is possible to prevent the mesh portion 213 from shifting to climb onto the lead screw 22, for example. Accordingly, it is easy to recover their meshed state, and the power can be transmitted stably even after the drop test.

In addition, as is sometimes the case, even while the optical pickup 12 is running, the torque needed for the stepping motor 24 may increase for some reason. An example of this is that, because the lubricant applied to the main guide shaft 13 runs short due to a long-time use, the movement load of the optical pickup 12 increases.

The increase in the movement load of the optical pickup 12 causes the same situation as the increase in the torque needed for the stepping motor 24 causes during the position detection in the inner peripheral end or in the outer peripheral end. For this reason, even if the tooth portions 214 do not come out of mesh with the feed groove 23, once their mesh is shifted, the power accordingly cannot be transmitted stably. Additionally, if the tooth portions 214 come in and out of mesh with the feed groove 23 like during the position detection, this causes a problem that the load imposed on the arm portions 212 increases as well.

Even in such a case, the embodiment can prevent the shift in the mesh between the tooth portions 214 and the feed groove 23. Specifically, when the amount of mesh between the tooth portions 214 and the feed groove 23 decreases as well as accordingly the tooth portions 214 nearly come out of mesh with the feed groove 23, the inclined surfaces 215S of the respective regulating portions 215 come into sliding contact with the periphery of the lead screw 22, and the tooth portions 214 are thus pushed back in the direction of the depth of the feed groove 23 (i.e., in the -X direction).

The mesh portion 213 moves mainly in the X-axis direction because of the regulating portions 215. For this reason, it is possible to prevent the tooth portions 214 from coming out of mesh with the feed groove 23 to a large extent even though the amount of mesh between the tooth portions 214 and the feed groove 23 may decrease slightly. In other words, even in a case where the movement load of the optical pickup 12 increases while the optical pickup 12 is running, the tooth portions 214 do not come out of mesh with the feed groove 23. Accordingly, the power can be transmitted stably, and the stable run can be realized.

Furthermore, the provision of the regulating portions 215 provided above and under the lead screw 22 in a way that the lead screw 22 is interposed between the regulating portions 215 makes it possible to reduce the minute vertical movement of the rack 21 (in the Y-axis direction) which occurs during the normal run of the optical pickup 12. Accordingly, the optical pickup 12 can run stably.

Moreover, the regulating portions 215 are formed integrally with the tooth portions 214. For this reason, even in a case where the tooth portions 214 nearly come out of mesh with (i.e., become more likely to come out of mesh with) the feed groove 23 while the optical pickup 12 is running, the regulating portions 215 can be made to function simultaneously with the detachment. Specifically, the peripheral surface 22S of the lead screw 22 is put into slide contact with the inclined surfaces 2155 of the respective regulating portions 215 at the same timing as the detachment starts, and the mesh portion 213 (the arm portions 212) is thus restrained from deforming in the Y-axis direction. Accordingly, the tooth portions 214 can be brought into mesh with the feed groove 23 again, and the optical output 12 can run stably.

In the optical pickup feeding device 2 of the embodiment, the regulating portions 215 are provided in the respective positions on the rack 21 (the mesh portion 213) between which the upper and lower portions of the lead screw 22 are interposed. The regulating portions 215 are not in contact with the lead screw 22 while the optical pickup 12 is running regularly (normally). When the tooth portions 214 of the rack 21 start to come out of mesh with the feed groove 23 of the lead screw 22, the regulating portions 215 come into contact with the peripheral surface of the lead screw 22, and causes the arm portions 212 to deform in the X-axis direction while restraining the rack 21 (the arm portions 212, or the mesh portion 213) from deforming in the vertical direction.

The embodiment has been described by using the case of the provision of the regulating portions 215 between the two tooth portions 214 as an example of the embodiment. Nevertheless, it suffices that the regulating portions 215 are provided integrally with the tooth portions 214 in the vicinity of the tooth portions 214. For example, the regulating portions 215 may be provided outside the tooth portions 214.

In this case, however, a larger area needs to be secured for the mesh portion 213, and the lead screw 22 needs to be made accordingly longer. From a viewpoint of making the apparatus in a smaller size, it is advantageous that the regulating portions 215 should be provided between the two tooth portions 214.

The following effects can be obtained from the present invention.

First, because the multiple regulating portions protruding more than the tooth portion of the rack are provided in the respective positions between which the upper and lower portions of the feed shaft in the vicinity of the tooth portion are interposed, it is possible to control the posture of the deformation of the rack while detecting the position of the optical pickup. In this respect, the “upper and lower portions of the feed shaft” are upper and lower portions on a peripheral surface of the feed shaft, between which a plane almost horizontal to a data recording surface of the optical disc is interposed. Specifically, while the position of the optical pickup is being detected after the optical pickup moves up to the inner peripheral end or the outer peripheral end of the optical disc, an increased torque of the stepping motor is added to the tooth portion of the rack, and the tooth portion comes out of mesh with the feed groove of the feed shaft. At this time, the regulating portions restrain the mesh portion provided with the tooth portion from deforming vertically to the feed shaft. Accordingly, it is possible to inhibit a thin portion of the rack from twistedly deforming.

Even in a case where the tooth portion comes out of mesh with the feed groove, the direction of the deformation of the rack (an arm portion) is limited mainly to a direction in which the tooth portion moves away from or closer to the feed shaft in a direction almost horizontal to the data recording surface of the optical disc by the regulating portions which are provided above and under the feed shaft in the vicinity of the tooth portion in a way that the feed shaft is interposed between the regulating portions. In other words, the regulating portions restrain the tooth portion (the mesh portion) from sliding to a large extent in a direction vertical to the feed shaft (i.e., in a direction perpendicular to the data recording surface of the optical disc). Accordingly, it is possible to reduce load which is imposed on the thin portion due to the twisted deformation of the thin portion in the rack, and thus to prevent the breakage of the rack.

Second, the regulating portions are formed integrally with the mesh portion on which the tooth portion is provided. For this reason, the regulating portions start to function at the same timing as the mesh between the tooth portion and the feed groove starts to shift. Thus, it is possible to control the posture of the mesh. Accordingly, it is possible to effectively prevent the condition which results in the breakage of the rack, and to realize a stable operation while the optical disc is running.

Third, even in a case where a force is applied to the rack during a drop impact test, it is possible to prevent the mesh portion from sliding in the vertical direction to a large extent, and the tooth portion from coming out of mesh with the feed groove. In other words, as is sometimes the case, for example, if the deformation of the arm portion is set inappropriately, the tooth portion is kept out of mesh with the feed groove once the mesh portion shifts in the Y-axis direction, and it is accordingly hard to recover the state of the mesh between the tooth portion and the feed groove. However, the embodiment causes the mesh portion to deform mainly in the X direction. For this reason, it is possible to prevent the mesh portion from sliding in the Y-axis direction to a large extent, and the tooth portion from coming out of mesh with the feed groove. It is easy to recover the state of the mesh between the tooth portion and the feed groove even if the tooth portion comes out of mesh with the feed groove. Accordingly, the power can be transmitted stably even after the drop.

Fourth, it is possible to prevent the shift in the mesh between the tooth portion and the feed groove, even in a case where, while the optical pickup is running, the movement load of the optical pickup increases for some reason and the torque needed for the driving motor accordingly increases. In other words, because the regulating portions provided above and under the feed shaft allow the tooth portion to move mainly only in the X direction, it is possible to prevent the shift in the mesh between the tooth portion and the feed groove even though the amount of mesh may decrease slightly. In sum, the advantage is that even in such a case, the power can be transmitted stably.

The provision of the regulating portions above and under the feed shaft makes it possible to reduce the minute vertical movement of the optical pickup (in the Y-axis direction) even while the optical pickup is running regularly, and enables the optical pickup to run stably.

What is claimed is:

1. An optical pickup feeding device for moving an optical pickup in a radial direction of an optical disc, comprising:
a feed shaft rotatably supported by a fixation board and provided with a spiral feed groove in a periphery of the feed shaft;
a driving motor for rotating the feed shaft; and
a driving member for driving the optical pickup by use of the driving motor and the feed shaft, wherein
the driving member comprises: a main body portion to which the optical pickup is fixed; a tooth portion in mesh with the feed groove; an arm portion supporting the tooth portion and the main body portion in a way that the tooth portion and the main body portion are spaced; and a plurality of regulating portions provided in positions, between which the feed shaft is interposed, along the periphery of the feed shaft in a vicinity of the tooth portion.

2. The optical pickup feeding device of claim 1, wherein each of the regulating portions is a protrusion protruding toward the feed shaft.

3. The optical pickup feeding device of any one of claims 1 and 2, wherein each of the regulating portions protrudes more than the tooth portion.

4. The optical pickup feeding device of any one of claims 1 to 3, wherein in each of the regulating portions, a surface opposed to the feed shaft is an inclined surface along a curvature of the periphery of the feed shaft.

5. The optical pickup feeding device of any one of claims 1 to 3, wherein
the tooth portion is provided in a plurality of locations, and
the regulating portions are provided between the adjacent tooth portions.

6. The optical pickup feeding device of any one of claims 1 to 5, wherein the regulating portions are formed integrally with the tooth portions.

7. The optical pickup feeding device of any one of claims 1 to 6, wherein in a case where an amount of mesh between the tooth portions and the feed groove decreases, the inclined surface of each regulating portion comes into sliding contact with the periphery of the feed shaft, and the tooth portions are thus pushed back in a direction of a depth of the feed groove.

8. An optical pickup supporting system comprising:
an optical pickup;
a fixation board;
a first shaft and a second shaft, provided to the fixation board, for supporting the optical pickup which moves in a radial direction of an optical disc; and
the optical pickup feeding device of any one of claims 1 to 7.
